(19) United States
(12) Patent Application Publication
(10) Pub. No.: US 2014/0290614 A1
(43) Pub. Date: Oct. 2, 2014

(54) ENGINE CONTROL SYSTEM AND METHOD

(71) Applicant: Caterpillar Inc., Peoria (IL)

(72) Inventors: Arvind Sivasubramanian, Peoria, IL (US); Christopher F. Gallmeyer, Peoria, IL (US); David J. Lin, Peoria, IL (US); Brett A. Zook, Cutler, IN (US)

(73) Assignee: Caterpillar Inc., Peoria (IL)

(21) Appl. No.: 13/851,377

(22) Filed: Mar. 27, 2013

(51) Int. Cl. F02D 41/00

(52) U.S. Cl. CPC F02D 41/0097
USPC 123/179.18

(57) ABSTRACT

An engine system includes a fuel supply unit configured to supply fuel into a combustion chamber. The engine system includes a fuel supply unit to regulate the supply of fuel into an inlet port via a fuel rail and an air supply unit configured to supply compressed air into the combustion chamber. A control system is configured to receive operating conditions of the engine system. Further, the control system includes a detector component configured to generate a control signal indicative of a start-up condition of an engine system. A switching component of the controller receives the control signal indicative of the start-up condition of the engine system from the detector component and further transmits a fuel supply control signal to the fuel valve based on an air-fuel ratio error signal, and transmit an air supply control signal to the choke valve based on an engine speed error signal.

### TECHNICAL FIELD

The present disclosure relates to an engine system, and more particularly to a method and a control system to regulate fuel supply and air supply in the engine system.

### BACKGROUND

In a typical engine system such as a gas fuel engine, the engine system may include at least one controller to control a specific variable of the engine system. Alternatively, a multi-input and multi-output controller may have different actuators to control a specific variable of the engine system. These controllers usually control speed of the engine system with a fuel flow and control of an air-fuel ratio with a charge or an air-flow in all operating conditions of the engine system. However, during start-up conditions of the engine system, the control of the speed with the fuel flow and the control of air-fuel ratio with the charge or air flow may not provide optimum results.

U.S. Pat. No. 4,903,656 discloses a method of controlling an air-fuel ratio by controlling an opening of a gas-flow valve and an air-flow valve. During engine start up, a controller completely closes the air-flow valve and controls the opening degree of gas-flow valve to attain the desired air-fuel ratio. After a predetermined time, the controller completely closes gas-flow control valve and controls the opening of air-flow valve to control the mixture ratio. However, there is still room for improvement in the art.

### SUMMARY

In one aspect, the present disclosure is related to an engine system having a fuel supply unit configured to supply fuel into a combustion chamber. The fuel supply unit includes a fuel valve configured to regulate the supply of fuel into an inlet port via a fuel rail. The engine system further includes an air supply unit configured to supply compressed air into the combustion chamber. The air supply unit includes a choke valve configured to regulate the supply of air into the inlet port via an air inlet manifold. A control system is configured to receive operating conditions of the engine system. Further, the control system includes a detector component configured to generate a control signal indicative of a start-up condition of an engine system. The control system further includes a switching component receives the control signal indicative of the start-up condition of the engine system from the detector component. The switching component configured to transmit a fuel supply control signal to the fuel valve based on an air-fuel ratio error signal, and transmit an air supply control signal to the choke valve based on an engine speed error signal.

In another aspect, the present disclosure provides a method of controlling a supply of fuel and air in the engine system. The method includes determining a current engine speed by means of an engine speed sensor. The method further includes comparing the current engine speed with a threshold engine speed. Further, the control system transmits a fuel supply control signal to the fuel supply control valve to achieve a pre-set air-fuel ratio. The control system may further transmit an air supply control signal to the choke valve to achieve a desired engine speed.

Other features and aspects of this disclosure will be apparent from the following description and the accompanying drawings.

### BRIEF DESCRIPTION OF THE DRAWINGS

FIG. 1 illustrates a schematic representation of an engine system, in accordance with an embodiment of the present disclosure;

FIG. 2 illustrates a block diagram of the control system, in accordance with an embodiment of the present disclosure; and

FIG. 3 illustrates a process flow chart for a method for controlling the supply of the fuel and the compressed air in the engine system.

### DETAILED DESCRIPTION

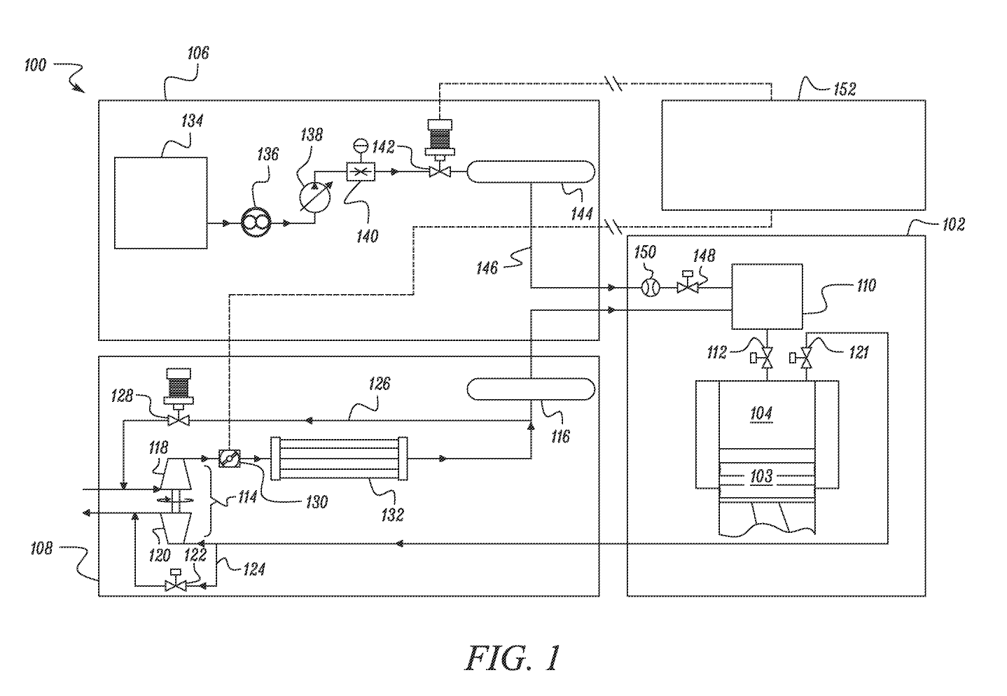

The present disclosure will now be described in detail with reference being made to accompanying figures. FIG. 1 illustrates a schematic representation of an engine system 100 in accordance with an embodiment of the present disclosure. Various embodiments described herein have been explained for a gaseous engine. However, it may be contemplated that the described embodiments may be implemented with any type of spark-ignited engine such as a gasoline engine, a natural gas engine, or an engine using gaseous fuels like propane, or methane.

The engine system 100 may include one or more cylinders 102 made of a metallic alloys such as steel, aluminum based alloys, etc. In the illustrated embodiment, the engine system 100 has been described in conjunction with a reference cylinder 102. The cylinder 102 may include a piston 103, which is adapted to reciprocate therein. The piston 103 may define a combustion chamber 104 within the cylinder 102.

The engine system 100 may further include an air supply unit 108 and a fuel supply unit 106 to supply air and fuel into the combustion chamber 104, respectively. The air supply unit 108 and the fuel supply unit 106 work in conjunction to provide an air-fuel mixture to be supplied into the combustion chamber 104. In an embodiment, the cylinder 102 may include an inlet port 110 operatively connected to the air supply unit 108 and the fuel supply unit 106. The air and the fuel supplied by the air supply unit 108 and the fuel supply unit 106, respectively, may be mixed at the inlet port 110 and the resultant air-fuel mixture is delivered into the combustion chamber 104. Further, the cylinder 102 may include an inlet valve 112 which regulates the admission of the air-fuel mixture into the combustion chamber 104 of the cylinder 102. It will be understood to a person having ordinary skill in the art that the inlet valve 112 may be a cam operated valve.

According to an exemplary embodiment of the present disclosure, the air supply unit 108 may include a turbocharger 114 to provide compressed air into an air inlet manifold 116 to be finally drawn into the combustion chamber 104. In general, ambient air is drawn into a compressor section 118 of the turbocharger 114 via one or more air filters (not shown). The turbocharger 114 also includes a turbine section 120 which is drivably connected to the compressor section 118 and configured to drive the compressor section 118 to compress ambient air. The turbine section 120 is configured to receive exhaust gases from the combustion chamber 104 via an exhaust valve 121. Further, a waste gate valve 122 is provided in the air supply unit 108 to control the flow of the exhaust gases through a turbine section bypass line 124, and thus controls a flow of the exhaust gases into the turbine section 120. Accordingly, the waste gate valve 122 is configured to control an air pressure within the air inlet manifold 116. In an embodiment, the air supply unit 108 further includes a bypass line 126 having a bypass valve 128 to relieve any excess air in the air inlet manifold 116 by controlling the opening of the bypass valve 128.

A flow of the compressed air from the turbocharger 114 is regulated via a choke valve 130 provided in the air supply unit 108. The choke valve 130 may be electronically controlled, but is normally maintained in a fully open except when it is required to create a vacuum in the air inlet manifold 116. The compressed air after leaving the choke valve 130 may pass through an after-cooler 132 before entering into the air inlet manifold 116.

In the exemplary embodiment, the fuel supply unit 106 may be a multi-point fuel injection system and include a low pressure fuel source 134, for example, an engine fuel tank or reservoir, to store the fuel. The fuel from the fuel source 134 may be transferred via a low pressure pump 136, such as a gear pump, to a high pressure pump 138, where the fuel is pressurized for further use. The fuel supply unit 106 may also include a fuel flow measurement which may be of a fixed or variable venturi 140 to measure a mass flow rate of the fuel therethrough. Further, a fuel valve 142 may be provided to regulate the supply of the pressurized fuel into a fuel rail 144, before being supplied to the combustion chamber 104 via one or more fuel lines 146 associated with the fuel rail 144. Further, the cylinder 102 may include a fuel admission valve 148 to regulate the delivery of the fuel from the fuel rail 144 into the combustion chamber 104. The fuel admission valve 148 may be of a type known in the art which controls the mass flow of the fuel into the combustion chamber 104, and also helps to maintain a pressure differential between the air inlet manifold 116 and the fuel rail 144 to facilitate a proper mixing of the air and the fuel at the inlet port 110. An orifice 150 may also be provided to measure a fuel mass flow rate through the fuel line 146 in the combustion chamber 104 of the cylinder 102.

In an embodiment, the cylinder 102 may also include a pre-combustion chamber (not shown) such that the fuel supply unit 106 may provide a relatively small amount of the fuel into the pre-combustion chamber. A check valve may be provided to regulate the fuel supply into the pre-combustion chamber wherein the initial ignition of the fuel takes place.

In an embodiment, the engine system 100 may include a control system 152 to control engine speed and regulate an air-fuel ratio. The control system 152 may be an electronic controller that may include a processor operably associated with other electronic components such as data storage devices and various communication channels. In an embodiment, the control system 152 may be operatively implemented within an engine control unit (ECU) associated with the engine system 100. The control system 152 is configured to receive various inputs indicative of the operating condition of the engine system 100, a desired engine speed, and a pre-set air-fuel ratio. According to an embodiment of the present disclosure, based on the operating condition of the engine system 100, the control system 152 is configured to transmit various output signal to selectively regulate the choke valve 130, the fuel valve 142 to achieve the desired engine speed and the pre-set air-fuel ratio and vice-versa.

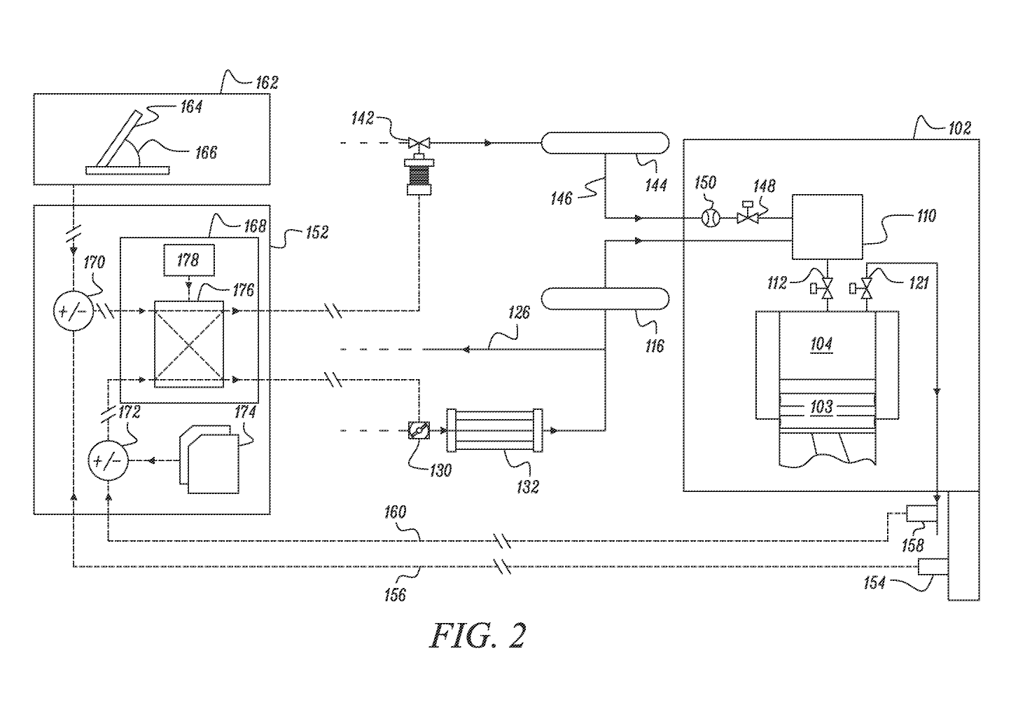

FIG. 2 illustrates a block diagram of the control system 152, in accordance with an embodiment of the present disclosure. As illustrated, the control system 152 is operatively connected to an engine speed sensor 154 via an engine speed communication channel 156. The control system 152 is configured to receive a speed signal from the engine speed sensor 154 which is indicative of the current engine speed and/or an operating condition of the engine system 100, such as, a cranking speed/start-up condition, a low-speed/cruise condition, and a high-speed condition. The current engine speed is commonly expressed in terms of crankshaft revolutions per minute (RPM), thus the engine speed sensor 154 may be associated with the crankshaft (not shown) of the engine system 100. Further, the control system 152 is connected to an air-fuel ratio sensor 158 via an air-fuel ratio communication channel 160. The control system 152 is configured to receive an air-fuel ratio signal indicative of a current air-fuel ratio. In an embodiment, the air-fuel ratio sensor 158 may include an oxygen sensor to monitor the current air-fuel ratio based on an exhaust gas mass flow rate and composition. Moreover, the control system 152 may also configure to receive various other signals indicative of for example, but not limited to, engine load, a coolant temperature, and a fuel pressure in the fuel rail 144. Further, one or more operator interface devices 162 which are operatively connected to the control system 152. In an embodiment, the operator interface devices 162 may include a throttle pedal 164 having a throttle position sensor (TPS) 166. The control system 152 is configured to receive a desired engine speed signal from the TPS 166 which is indicative of the desired engine speed commanded by an operator.

According to an embodiment of the present disclosure, the control system 152 may include a closed loop feedback controller 168, a first comparator 170, and a second comparator 172. The first comparator 170 may include an arithmetic logic and/or adder circuits and is configured to receive the current speed signal from the engine speed sensor 154 and the desired engine speed signal from the TPS 166 to generate an engine speed error signal. Further, the second comparator 172 may also include an arithmetic logic and/or adder circuits and is configured to receive the air-fuel ratio signal from the air-fuel ratio sensor 158 and a pre-set air-fuel ratio to generate an air-fuel ratio error signal. The engine speed error signal may be indicative of a difference between the desired engine speed and the current engine speed, and the air-fuel ratio error signal may be indicative of a difference between the pre-set air-fuel ratio and the current air-fuel ratio. In an embodiment, the pre-set air-fuel ratio may be based on the operating conditions of the engine system 100 and can be selected from a module map 174 stored in the control system 152. The pre-set air-fuel ratio may be calculated using a mathematical model using the various inputs such as, the current engine speed, ambient temperature, and ambient pressure.

The controller 168 may be a multi-input and multi-output (MIMO) controller including a switching component 176 and a detector component 178. The switching component 176 may be a predictive fuzzy control component configured to selectively regulate the opening and closing of the choke valve 130 and the fuel valve 142 based on the engine speed error signal and the air-fuel ratio error signal. The switching component 176 is configured transmit a fuel supply control signal to the fuel valve 142 and an air supply control signal to the choke valve 130 to achieve the desired engine speed and the pre-set air-fuel ratio based on the engine speed error signal and the air-fuel ratio error signal.

The detector component 178 is configured to determine the start-up condition of the engine system 100 based on the current speed signal received from the engine speed sensor 154. In an embodiment, the detector component 178 may compare the current engine speed with a threshold engine speed to determine the start-up condition of the engine system 100. The threshold speed may be substantially equivalent to a cranking speed of the engine system 100 and may vary based on the operating condition of the engine system 100. Further, in an embodiment, the detector component 178 is configured to generate a control signal indicative of the start-up condition of the engine system 100 if the current engine speed is lower than the threshold engine speed. Further, it may be contemplated that the start-up condition of the engine system 100 may be determined by other means, such as, cranking speed, compression ratio in the cylinders, etc., which are well known in the art.

During a normal mode of operation of the engine system 100, the switching component 176 may transmit the fuel supply control signal to the fuel valve 142 based on the engine speed ratio error signal to achieve the desired engine speed and transmit the air supply control signal to the choke valve 130 based on the air-fuel ratio error signal to achieve the pre-set air-fuel ratio. According to an embodiment of the present disclosure, the switching component 176 may receive the control signal from the detector component 178, during the start-up condition of the engine system 100. Accordingly, the switching component 176 dynamically vary the input-output pairing and transmits the fuel supply control signal to the fuel valve 142 based on the air-fuel ratio error signal to achieve the pre-set air-fuel ratio and transmits the air supply control signal to the choke valve 130 based on the engine speed ratio error signal to achieve the desired engine speed.

### INDUSTRIAL APPLICABILITY

The industrial applicability of the control system described herein will be readily appreciated from the foregoing discussion. In a typical engine system, the engine speed may be controlled by regulating the fuel supply, and on the other hand, the air-fuel ratio of the air-fuel mixture may be performed by regulating the air supply, irrespective of any operating conditions. This is done by opening a fuel valve at variable proportions in order to provide a prescribed fuel supply to achieve the desired engine speed. Further, the air supply is regulated by adjusting a choke valve to achieve a pre-set air-fuel ratio.

However, during start-up condition of the engine system, the supply of the compressed air may be affected by various factors for example, the cranking speed, ambient temperature and pressure, etc., and therefore may fluctuate repeatedly. On the other hand, it may be required to maintain the pre-set air-fuel ratio during the start-up condition in order to avoid stalling of the engine system. As will be understood from the following description, the embodiments of the present disclosure provide a control system and method to achieve the desired engine speed and the pre-set air-fuel ratio, and also avoid stalling of the engine system.

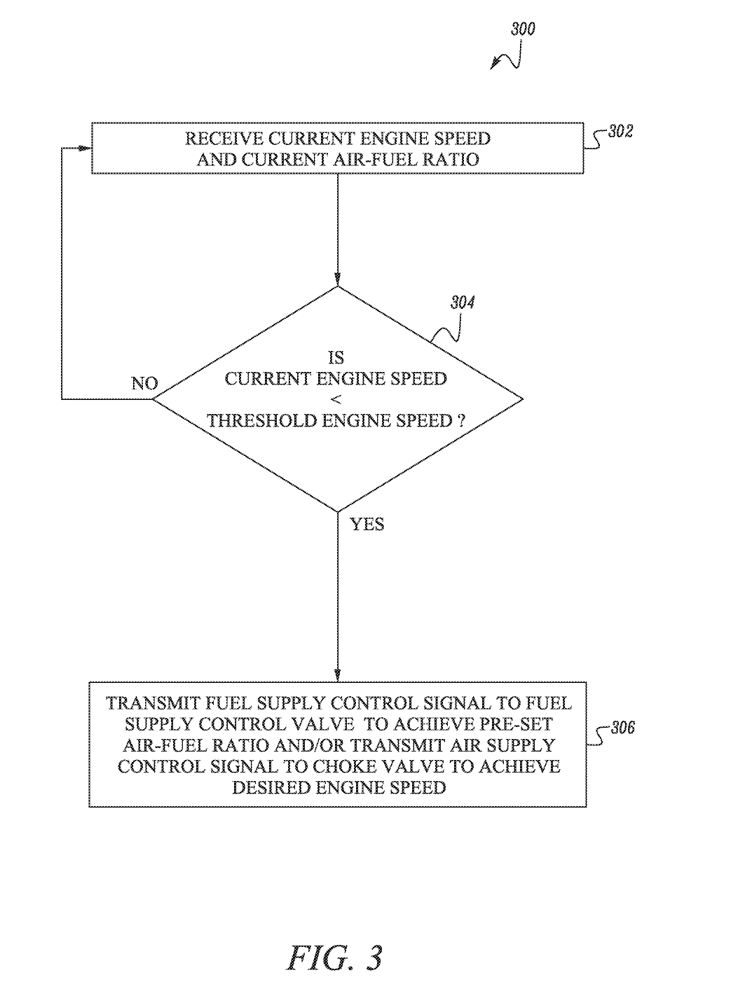

FIG. 3 illustrates a process flow chart for a method 300 for controlling the supply of the fuel and the compressed air in the engine system 100 during the start-up condition, in accordance with an embodiment of the present disclosure. At step 302, the current engine speed may be determined by means of the engine speed sensor 154. The engine speed sensor 154 generates the engine speed signal corresponding to the current measured engine speed, and subsequently transmits the current engine speed signal to the control system 152. The current air-fuel ratio may be determined by means of the air-fuel ratio sensor 158. Further, at step 304, the detector component 178 of the controller 168 may compare the current engine speed with the threshold engine speed. The detector component 178 may determine the start-up condition if the current engine speed is lower than the threshold engine speed. At step 306, the switching component 176 may vary the input-output pairing, if the engine system 100 is in the start-up condition (Step 304: YES), to transmit the fuel supply control signal to the fuel valve 142 based on the air-fuel ratio error signal to achieve the pre-set air-fuel ratio and/or transmit the air supply control signal to the choke valve 130 based on the engine speed ratio error signal to achieve the desired engine speed. As described above, during the start-up condition of the engine system 100 the supply of the compressed air may be affected by the cranking speed, ambient temperature and pressure. Thus, in an exemplary embodiment, during the start-up condition of the engine system 100, the air supply control signal may cause the choke valve 130 to selectively open at a fixed position to achieve the desired engine speed and the fuel supply control signal may be used to regulate the opening of the fuel valve 142 to achieve the pre-set air-fuel ratio. If the current engine speed is more than the pre-defined engine speed (Step 304: NO), the process flow chart moves back to step 302.

Although the embodiments of this disclosure as described herein may be incorporated without departing from the scope of the following claims, it will be apparent to a person skilled in the art that various modifications and variations to the above disclosure may be made. Other embodiments will be apparent to those skilled in the art from consideration of the specification and practice of the disclosure. It is intended that the specification and examples be considered as exemplary only, with a true scope being indicated by the following claims and their equivalents.

What is claimed is:

1. An engine system comprising:
a fuel supply unit configured to supply fuel into a combustion chamber, the fuel supply unit including a fuel valve configured to regulate the supply of fuel into an inlet port via a fuel rail;
an air supply unit configured to supply compressed air into the combustion chamber, the air supply unit including a choke valve configured to regulate the supply of air into the inlet port via an air inlet manifold; and
a control system configured to receive operating conditions of the engine system, the control system comprising:
a detector component configured to generate a control signal indicative of a start-up condition of an engine system; and
a switching component receives the control signal indicative of the start-up condition of the engine system from the detector component, the switching component configured to transmit a fuel supply control signal to the fuel valve based on an air-fuel ratio error signal, and transmit an air supply control signal to the choke valve based on an engine speed error signal.

2. The engine system of claim 1, wherein the detector component is configured to:
receive a current engine speed signal indicative of a current engine speed;
compare the current engine speed with a threshold engine speed;
generate the control signal indicative of the start-up condition of the engine system if the current engine speed is lower than the threshold engine speed.

3. The engine system of claim 1, wherein the control system further includes a first comparator configured to receive the current engine speed signal and a desired engine speed signal.

4. The engine system of claim 3, wherein the first comparator is configured to receive the current engine speed signal from an engine speed sensor and the desired engine speed signal from a throttle position sensor.

5. The engine system of claim 1, wherein the engine speed error signal is indicative of a difference of the desired engine speed signal and the current engine speed signal.

6. The engine system of claim 1, wherein the control system further includes a second comparator configured to receive an air-fuel ratio signal and a pre-set air-fuel ratio signal.

7. The engine system of claim 6, wherein the second comparator is configured to receive a current air-fuel ratio signal by an air-fuel ratio sensor.

8. The engine system of claim 6, wherein the control system further includes a module map, the pre-set air-fuel ratio is selected from the module map.

9. The engine system of claim 8, wherein the air-fuel ratio error signal is indicative of a difference of the pre-set air-fuel ratio and the current engine air-fuel ratio.

10. A control system for an engine system comprising:
a controller including:
a detector component configured to generate a control signal indicative of a start-up condition of an engine system;
a switching component receives the control signal indicative of the start-up condition of the engine from the detector component, the switching component configured to:
transmit a fuel supply control signal to the fuel valve based on an air-fuel ratio error signal; and
transmit an air supply control signal to the choke valve based on an engine speed error signal.

11. The control system of claim 10, wherein the detector component is configured to:
receive a current engine speed signal indicative of a current engine speed;
compare the current engine speed with a threshold engine speed;
generate the control signal indicative of the start-up condition of the engine system if the current engine speed is lower than the threshold engine speed.

12. The control system of claim 10, wherein the control system further includes a first comparator configured to receive the current engine speed signal and a desired engine speed signal.

13. The control system of claim 12, wherein the first comparator is configured to receive the current engine speed signal from an engine speed sensor and the desired engine speed signal from a throttle position sensor.

14. The control system of claim 10, wherein the engine speed error signal is indicative of a difference of the desired engine speed signal and the current engine speed signal.

15. The control system of claim 10, wherein the control system further includes a second comparator configured to receive an air-fuel ratio signal and a pre-set air-fuel ratio signal.

16. The control system of claim 15, wherein the second comparator is configured to receive a current air-fuel ratio signal by an air-fuel ratio sensor.

17. The control system of claim 15, wherein the control system further includes a module map, the pre-set air-fuel ratio is selected from the module map.

18. The control system of claim 17, wherein the air-fuel ratio error signal is indicative of a difference of the pre-set air-fuel ratio and the current engine air-fuel ratio.

19. A method of controlling a supply of fuel and air in an engine system, the engine system including a controller connected to a fuel supply control valve and a choke valve, the method comprising:
determining a current engine speed by means of an engine speed sensor;
comparing the current engine speed with a threshold engine speed;
transmitting a fuel supply control signal to the fuel supply control valve by the controller to achieve a pre-set air-fuel ratio; and
transmitting an air supply control signal to the choke valve by the controller to achieve a desired engine speed.

20. The method of claim 19, further includes receiving a signal indicative of the desired engine speed from a throttle position sensor.
